(19) United States
(12) Patent Application Publication
(10) Pub. No.: US 2008/0024299 A1
(43) Pub. Date: Jan. 31, 2008

(54) Method and Means for Context-Based Interactive Cooperation

(76) Inventor: Hans Robertson, Jonkoping (SE)

Correspondence Address: HARNESS, DICKEY & PIERCE, P.L.C., P.O. BOX 8910, RESTON, VA, 20195, US

(21) Appl. No.: 10/583,659

(22) PCT Filed: Dec. 21, 2004
(86) PCT No.: PCT/SE04/01967

§ 371 Date: Mar. 30, 2007

(30) Foreign Application Priority Data
Dec. 22, 2003 (SE) 0303568-0

(51) Int. Cl. G07C 1/00

(52) U.S. Cl. 340/572.1

(57) ABSTRACT

The present invention relates to a method and an arrangement for a second individual having a context log which contains information about contextual aspects, related to the second individual, as a function of time, to read information from a first individual's context log which contains information about contextual aspects, related to the first individual, as a function of time. From information from the context log of the first individual, a context graph of the first individual is generated, available to the second individual, which shows contextual aspects as a function of time, and at least a contextual aspect which refers to at least one location of the first individual and a contextual aspect which refers to at least one activity on a work- or individual-related object with the same location as the first individual are included in the context graph, and the context graph shows contextual aspects for a period of time which comprises both present time and a period of the past in connection with the present time.

The present invention relates to a method and an arrangement for context-based interactive cooperation.

### BACKGROUND OF THE INVENTION

When a group of individuals cooperate with each other, you now and then need to come into interactive contact with an individual who is in a place where he cannot be seen. The contact may involve, for instance, that you want to find the individual, try to reach him on the telephone, send a message etc.

When you feel the need of contacting a certain individual, you do not usually know whether you will be successful. Nor do you know whether the contact will disturb the individual in his work. This uncertainty causes friction in the cooperation. If the contact fails, you often try to leave a message (voice, SMS, mail, messenger, letter etc), but you rarely know when you will receive an answer. This means that the interactive contact you tried to establish failed when you wanted it, and you will remain uncertain of when the contact attempt will lead to a result.

Owing to the uncertainty, you may try to compensate for your need by contacting another individual or other individuals and, thus, the same matter will circulate and disturb a plurality of individuals. If this contact is successful, you may interrupt the matter in which the individual is engaged and the individual's own planned tasks are disturbed in a manner which will then affect himself and also other individuals. All this results in a loss of time and turbulence in the cooperation in the group and may cause costly frictions and disturbances in the business or social consequences if the members of the group are more focused on such aspects.

An important reason for these problems is that the current context in which the individual you want to contact is positioned is not known to you. Attempts have been made to solve this problem using different means in connection with mobile phones. Examples of such suggestions are disclosed in EP 1217849, WO 0141457, U.S. Pat. No. 5,742,905 and WO 9966747.

Use is generally made of a method of detecting the work context of the individual called and then automatically giving the calling individual information about in which state the called individual is or ensuring that the call attempt will be automatically handled when the called individual then is in a suitable context.

There may be reasons to consider the discussed problems from a behavioural perspective.

The situation where we find ourselves affects and controls us consciously or unconsciously in our further actions. This controlling situation may be called the context in which we find ourselves. The context may be characterised by different aspects: where we are positioned, the individuals which are in our vicinity, the objects or tools, with what we are engaged, with which individuals we interact etc, but also for how long these features have existed and affected us. In aspects of context, it may also be included how we visualise the future, for instance how long time is available to achieve a certain result.

Our capability of observing different aspects of context is decent, but our capability of remembering in detail aspects of context is generally quite weak. It is difficult to remember straight away what we did an ordinary day a week ago and how our context changed during that day, and it may even be difficult to remember the same things of yesterday or even an hour ago.

The context may help us to remember, to make decisions, to make assessments, to plan and so on. By returning to the same place, we can be reminded of what we were doing there, by noticing a scent we can be reminded of things that we experienced when we noticed the same scent etc.

The context in which we find ourselves affects our behaviour and our decisions. As a rule we are pretty unaware of how this happens. If we have a good description as the function time of the context in which we have found ourselves, we can generally assess what we have done during a certain period of time and maybe also begin to understand the reasons why we did what we did. In that case, this might serve as guidance to realising what we need to do for the time to come, i.e. planning documentation.

A fairly detailed description of context makes it easier for us to remember and implies that we can later add aspects of context that are missing so that the description will be more complete. Especially when the completions must be based on our assessments, it is often easier to add them successively.

Active processing of this type may also lead to reflections and means that we will begin to understand why we are doing what we are doing. The more we refine the image of context, the easier it is to make the image more and more distinct. It means that if, also after a long time, you return to the image, the inner image of what happened exactly at that moment can be sharp. This creates a context that allows you to assess whether what you did on the occasion can be useful to the matter in which you are involved right now.

It may also result in the possibility of reflecting upon how you should have acted instead to arrive at a result that was better than the one actually obtained. If the context can be represented in distinct images, it would facilitate the work of processing, reinforcing and refining it as regards the past, present times as well as future. By sharing such images, or in any case images with specially selected aspects of context, with others, it will be possible to create a better base for interaction since individuals are included in each other's contexts.

### OBJECTS OF THE INVENTION

A first object of the invention is to create, in a group of cooperating individuals, a clear image of the context in which the members of the group are positioned. It will then be natural and advantageous for the members of the group to study this image as background information and let it influence the decisions and actions that concern interactive cooperation in the group.

According to the invention, it is made easy for the members of the group to come into appropriate interactive contact with each other, when required, by a visit or by communication, and to assess which disturbance a contact with another member of the group can be expected to cause.

### DESCRIPTION OF THE INVENTION

Individuals and their environment are provided with tags with sensors which automatically can register aspects of context, for instance current location (place of presence), reachability via communication means, interaction with or use of tools, presence of or interaction with other individuals etc. By a tag is meant in this context a small electronic unit which can be allocated to individuals, objects, work objects, tools, premises etc, allowing them and their state to be detected automatically. The tags can communicate with, for instance by radio, physical networks or with other suitable means. The information from them is collected, buffered and compiled to make the information available for the individual, for example, in the computer or computers he uses in his work, or in a separate display.

The sensors generate information that can be expressed in contextual aspects and stored on a storage medium as a log and then processed to context graphs as a function of time for the members of the group. Such contextual aspects can be made available to the individual and comprise at least the past and present times, but may also comprise planned states for a contextual aspect for future times.

It is known to register such information that can be used to indicate an aspect of context.

U.S. Pat. No. 5,555,376 discloses how it is possible to collect contextual information which is there used for the purpose of controlling apparatus based on the context in which the user is positioned. EP 1217860 discloses how it is possible to collect contextual information in a log and use it to generate context-based suggested decisions to guide a user. US 2003013459 discloses how it is possible in an amusement park to follow a visitor's activities and collect information about his activities.

Registered contextual aspect information can be collected in a memory whose contents are then processed, sorted and compiled in a context log containing information about aspects of the person's context as a function of time. This log can then be processed and be made available in the form of a context graph. The context graph can suitably be displayed on a screen of a computer, on the display of an advanced mobile phone, a personal digital assistant or the like, or by a means capable of displaying an image. Interaction with the context graph can take place, for example, by means of a pointing device and a keyboard, or other input means.

Such graphs can show where the individual has been (place of presence), which other individuals were there at the same time, what tools have been active, the setting of the tool, the working posture used etc. If the tool is computer-like, it is possible to show for instance pointing device or key activities, active application, file name thereof, printout on printer, number of sheets printed etc.

An individual comes into contact with a number of work- or individual-related objects during a workday. Vehicles and tools may be involved, workpieces in the form of future products or parts of products that are processed, packed and delivered, incoming material or components that are processed etc. Also binders, furniture etc. that are used in work may be involved.

Individual-related objects can be a wallet, an article of clothing, a bunch of keys, a mobile phone, a personal digital assistant etc.

Objects as described above can be provided with tags and generate contextual aspects that may be included in the individual's log and then be used to generate traces in the individual's context graph, which makes it easy for him to keep track of what he was doing during the day.

When working with communication tools, it is possible to include, for instance, states and activities of these such as engaged, switched off, reachable only in certain ways, called person, dialled phone number or other addressing, called by an identified person, called by an identified phone number. The documentation which the individual produces in the course of the work by means of his tools (computer, mobile phone, personal digital assistant or the like) can also be marked and shown and be made available via the context graph. Also messages in text form, such as mail and SMS, or in image or sound form that have been exchanged with other individuals can be shown in the graph with explanatory text about the character of the message.

The log can also be used to show messages to itself, which may then have the character of notes and the mark can refer to the point of time when the message or note was stored in the context log. For example, it is possible to use a mobile phone and give a message and let this message be indicated in the log at the point of time it was generated and let it be reproduced if the indication in the log is activated.

If it is advantageous, it is possible now and then to supplement the automatically registered aspects of context with manual ones in order to elucidate, when required, the image of what has happened. For instance, some individuals may not be provided with automatic means, and it may then be necessary to make manual marks for them.

It is also advantageous to be able to use the graph to show future aspects of context which are planned or expected to occur. Plans for activities or meetings may be involved. Once the point of time occurs when the planned time changes into present, it is advantageous to let the traces of the planning be included in the historical context graph to allow the planning to be compared with what actually happened.

All such context signals help the individual to remember what he has accomplished.

Based on the marks in this context graph, the individual can then mark the period of time during which he worked with a certain task and allocate it to a working account that he has chosen in connection with the context graph. In this manner, it is easy to provide a detailed account of working time.

The accounting of working time is suitably made now and then during the day while it is still easy to remember, by means of the context marks, what has been accomplished. The resulting working time account can then be stored in the same log and may then be included as part of the context log, thus accentuating it further.

The accounts can be summarized so that total worked time during the day is shown, total worked time from the beginning or for a specified calendar period. Estimated time can also be entered, and reduced by worked time, in order to show remaining time and also adjust it if is found to deviate from the estimation.

Not only people need to account for worked time. This applies also more important objects, such as working machines, expensive computer equipment, plotters and printers, exclusive work tools, etc. For these objects, context logs can be created in a similar way as for persons, and include context aspects regarding who has used them, for what, and for how long, and thereby provide guidance how to account for used time. Objects that are moved to the tool may also be traced, and the time during which the tool has been used for a certain object.

For documentation of different kinds, such as notes, recorded messages, files, images, video sequences and or other multimedia documentation, it is possible to use the context graph to relate the documentation to a contextual aspect shown in the context graph. This makes it easy for the individual to find it and to assess its relevance by means of the context with which it has thus been catalogued. When a plurality of individuals interact and exchange information, possibly based on contextual aspect, it may be important to include how other individuals or oneself has communicated regarding the documentation, for instance in the respects sent to, received from, opened by, checked by, read by, commented on by, printed by etc.

It is possible to distinguish between two types of information, a part that you want to share with others and matters that you want to keep to yourself, until further notice or permanently.

The documentation with which the individual comes into contact and which has relevance to the work or which he performs himself in the course of the work by means of his ordinary tools, can be catalogued in the context graph and allocated to the working account to which it belongs and to the point of time to which it was relevant. It can also be catalogued by means of one or more contextual aspects, such as account, individual, work or individual-related object etc. Thus, the continuous documentation gets into a context which allows the context to be kept, which automatically gives the documentation a more distinct limitation. Once this documentation is included in the context, the context will be still more accentuated.

In the context graph the documentation can be indicated with an icon and, by interacting with the icon, it is possible to access the documentation. It is also possible to choose to access the documentation via one or more contextual aspects to which it has been catalogued. This means that there will be a distinct context log which can be graphically oriented, where it is possible to clearly follow your tasks and the documentation to which it has been connected. This makes it easy to repeat what happened during a day, and you will get clear associations to remind you also of matters that have not been documented.

This also means that the documentation will be put in order and be well structured, and by returning back in time via an account structure or a calendar, it will be possible to quickly find documentation connected to specific tasks. By documentation being catalogued and indicated in the context, also the individual's own reflections can be collected in such documentation and thus get into a clear context, which creates conditions for fast learning. Above all it will be easy to analyse how you interact with other individuals when cooperating and how you take up the time of others and how others take up your own time and how this affects the time it takes to perform a task and the effect on quality this may have. Also the observations made of this may then suitably be included as a part of the context log.

This advanced and accentuated context creates possibilities of analysing your own workday and also understanding why it developed as it did. For instance, it is possible to see the effect of frequent disturbances and interruptions and thus begin to realise how you should control your day to make it successful and also to better understand how to interact with others.

By the documentation being included in a context that contains aspects that are shared by individuals with whom you interact, excellent conditions will now be created to share such documentation within a working group in a quick, distinct and time-saving manner.

Contextual aspects can be used not only as aids for an individual but also for a group. Interactive cooperation in a group can be facilitated if it is possible to communicate information that reflects the context (situation) in which the members of the group find themselves.

This may occur, for instance, by context graphs being shown with selected contextual aspects for individuals in the group. They can provide guidance on deciding to contact the individual or refrain from doing so. They can also make it easier to choose whom to contact if more than one can assist in meeting the current need. They may also show that the individual in question would be disturbed by an attempt to be contacted.

The context graph for an individual is not only the instantaneous situation but may also comprise how the situation has turned out for some time before the present (the wake). The image of the context as a function of time during a preceding period can facilitate the assessment of the consequences of the attempt to be contacted for the further situation. The context graph may also comprise what the plans for the individual's activity look like for the future.

The context graph may provide support to make it possible to assess whether the individual you want to contact is reachable and to understand the disturbance a contact on this occasion could cause. For instance, the individual may be deeply engaged in a task which requires great concentration and in which an interruption would have a detrimental effect. It will then be possible to weigh the risk of disturbance against the benefit in the current case.

If context graphs are shown simultaneously to a plurality in a group of individuals who could assist in performing a task, conditions are created to make it possible to choose to contact the one who will have a good effect from his own and from the group's point of view. If context graphs are available more or less continuously, you learn to see patterns in the behaviour of the members of the group. This may gradually influence your understanding and taking into consideration of their contactability and sensitivity to disturbance.

An individual may extend the contextual aspects that are shared with others. For instance, an individual may add contextual aspects showing which tasks he has worked with and for how long, allocated working time, and documentation which has been generated while working and which he wants to share with others in a rational manner. He can lay down conditions for such sharing of contextual aspects to apply to the members of the group who, for instance, have reported in which tasks they have been engaged and the documentation connected thereto for a reciprocal period of time. Particularly in a situation under stress, an individual must know what the others in the group are doing and what documentation they have provided about this. If an individual knows that it is possible to be informed about this only if he manages his own part, then he will have an incentive to really manage his own part since otherwise he cannot see what others are doing.

It is possible to extend and generalise the system to share information about contextual aspects between the members of a group so that a second individual will not be informed about contextual aspects of a first individual to a greater extent than the extent at which the second individual made his own information available to the first individual for a reciprocal or corresponding period of time.

This is conveniently arranged in such a manner that by way of introduction each individual can define the restrictions he wants to make as regards the availability of his contextual aspects to different individuals in a group or to groups of individuals. It is then checked against each individual when new contextual aspects become available if he has himself made the corresponding contextual aspect available to such an individual for a reciprocal period of time. If this is not the case, he will not be informed about the current contextual aspect of this individual.

In this way the system will be self-stabilising. Since an individual's own working context graph also shows him in a distinct manner what he has done he will obtain an increasing understanding for the value of continuously reporting to other individuals how the work proceeds; it saves time.

In order not to make restrictions by mistake, it is suitable to show a consequence of the restrictions made to others, for instance by these contextual aspects being erased for them, thus clearly indicating that this is due to the fact that an individual does not want to make his own contextual aspects of this type visible to the individual in question. It may also be important that an individual with his context graph be included in the group so that he sees an image of the information he shares with others and here also can see restrictions that he has made.

This method means that there will be no big brother in the system who can watch you without being seen and an individual determines to what extent he wants to be seen, but is not allowed to see more of others than he himself is willing to show.

The reciprocal period of time can be defined in several ways and can be differently defined for different aspects of context. It may also need to be adjusted and be formed in detail so as to suit the needs of a specific group. The period of time can be a fixed and predetermined period of time. For example, it may comprise a special day, week or month or be determined to apply to a predetermined task of a predetermined or restricted length. It may also have a fixed length, however rolling to the present, for instance so as to comprise three hours of the past and six hours of the future or the preceding, current week and coming day, week or month.

In another method, an individual will be informed about the contextual aspects of others for a certain extra time after he has given away a corresponding type of contextual aspects; for instance if he has shared contextual aspect information with others for a certain day, he can be allowed to receive information of others for a subsequent hour, half day or day. It may sometimes be convenient to make the extra time short, just one or a few minutes.

The method can be used, for example, to arrange for an individual to see in his own context log another member of the group only if he is in the same location and if he can also see the individual seeing him. This may occur by an individual defining the reciprocal period of time as the same period of time, i.e. the case when two individuals are in the same place at the same time. It can then be said that there is a short period of time rolling in time.

When a contextual aspect related to documentation is shared, the system can, when such documentation is being opened, register this and state the point of time of this in the graph, for example by indicating a signature of the current individual at the current point of time in connection with a documentation icon or a contextual aspect to which the documentation is catalogued. The individual opening the documentation can also indicate what he has done with the same, for instance read, checked or commented on the same. These events can also be marked, for example by giving the signature a special character.

By sharing relevant contextual aspects, the work in the group can be facilitated in interactive contacts where it is important to take the context in which an individual is positioned into consideration.

It is also important in a group to share contextual information, for example, in the form of allocation of tasks and catalogued documentation. These contextual aspects give the group a clear picture of how the work in the group proceeds and make it easier for the members of the group to select the correct approach of the work.

### DESCRIPTION OF FIGURES

FIG. 1 illustrates a number of different types of tags that can be used to generate in an automated manner contextual aspect information that will be included in a context log.

FIG. 2 illustrates how tags and network interact in a location to create a context log.

FIG. 3 illustrates how different types of network can interact to create context logs.

FIG. 4 illustrates how to use different means to create context logs in a workroom.

FIG. 5 illustrates how context logs can be created and handled and how different contextual aspects in different logs can be related to each other and thus be included in each other for an individual and for an object. FIG. 5 also shows how it is possible to interact with a context graph.

FIG. 6 shows examples of how a number of individuals can exchange contextual aspect information.

FIG. 7 shows examples of how contextual aspects for past time and future can be presented in a context graph. These examples are aimed in the first place at cooperation in terms of work.

FIG. 8 illustrates more examples of context graphs and how it is possible to restrict which contextual aspects an individual is prepared to share with others.

FIG. 9 shows a variant of context graphs for more socially oriented cooperation.

### DESCRIPTION OF EMBODIMENTS

In the following the invention will be described in a number of embodiments. They are to be regarded only as a few examples of a large number of variants of the invention and should in no way be considered to limit the invention.

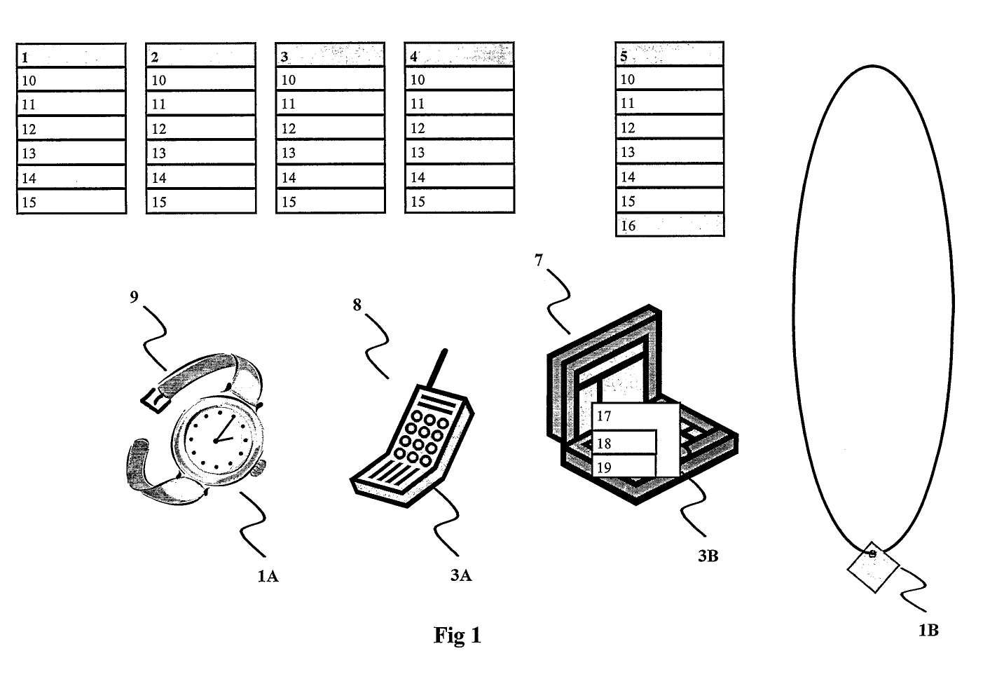

FIG. 1 exemplifies means that can be used to help to generate, in an automated manner, information about aspects of the context in which an individual or an object can be positioned and which is to be included in a context log.

The Figure illustrates the structure of a person tag 1, which can be provided with one or more antenna systems 10, one or more communication systems 11, one or more sensors 12, means for data processing and storage 13, and other analogue and digital electronics 14 used to make the different parts of the autolog cooperate. Finally there are power supply means 15, such as a battery or a connection to some other power supply. Some kind of protective encapsulation is also included.

The person tag can be an independent unit, for instance as illustrated by 1B where it has a cord and suitably can be worn around the neck, or it can be an integrated tag 1A in a watch 9. This type of tag is used for the individual to obtain automatic marks in his context graph and, to ensure this, a tag can therefore be allocated to one or more personal objects normally used by an individual in his daily work. It can be placed in a wallet, a mobile phone, a bunch of keys or the like.

Several types of tags have a more or less similar structure. The exact classification is not very important, and the following description is only exemplifying and does not comprise a complete enumeration.

A tag can be designed as an object tag 2. It can be used for different types of objects, for instance a work object which is to be processed and which is moved in a workroom between different tools. The object tag is conveniently provided with sensors that can indicate a movement or change. It can also be used to designate deliveries etc. It can also be used to designate important binders or instructions.

Another tag can be a tool tag 3 which is attached to tools that are particularly important in the business, for instance a mobile phone, a special instrument, a tool, a computer or the like. If a telephone is involved, the sensors 12 of the tag can be adapted to detect whether the telephone is engaged in a call. A tool tag can also be used to mark working furniture, in which case its sensors can detect the working posture or setting of furniture.

Yet another type of tag is a position tag 4 which is permanently attached in a position to indicate its identity for the context log. Sensors 12 can be used, for example, to detect light and temperature in the position. A position tag 4 can have its own power supply 15 connected to permanent electric mains, but can also be operated by a battery. A variant of this position tag can have a sensor consisting of a GPS receiver, thus allowing the tag to keep track of its geographic position.

A special type of tag is a log tag 5 which can be provided with one or more antenna systems 10, one or more communication systems 11, one or more sensors 12, means for data processing and storage 13, and other analog and digital electronics 14 used to make the different parts of the autolog cooperate. The power supply 15 may consist of, for instance, a battery or a connection to some other power supply. There are also means for storing of logged information 16.

A tag can be built into or integrated with an object normally used by the individual in his work, for instance a watch 9 with a tag 1A, a mobile phone 8 with a tag 3A, or a mobile computer 7 with a tag 3B.

For the objects which are of the tool type, a tool tag 3 or a log tag 5 can often be integrated with the hardware and can, in the extreme case, consist of software. This may be the case, for example, when the tool is a computer 7, but may also apply to a qualified mobile phone 8 or a personal digital assistant or some other tool with a qualified data processing and communication capacity.

The tag program 17 is integrated in the software of the computer 7. The sensor part 18 in the software generates information about how the computer is used, about the documentation generated and about the interaction with log information which the individual performs by means of the tool. The communication part 19 is used in the program to transmit information to the place or the places where the context log then is to be stored and where it is included in the same.

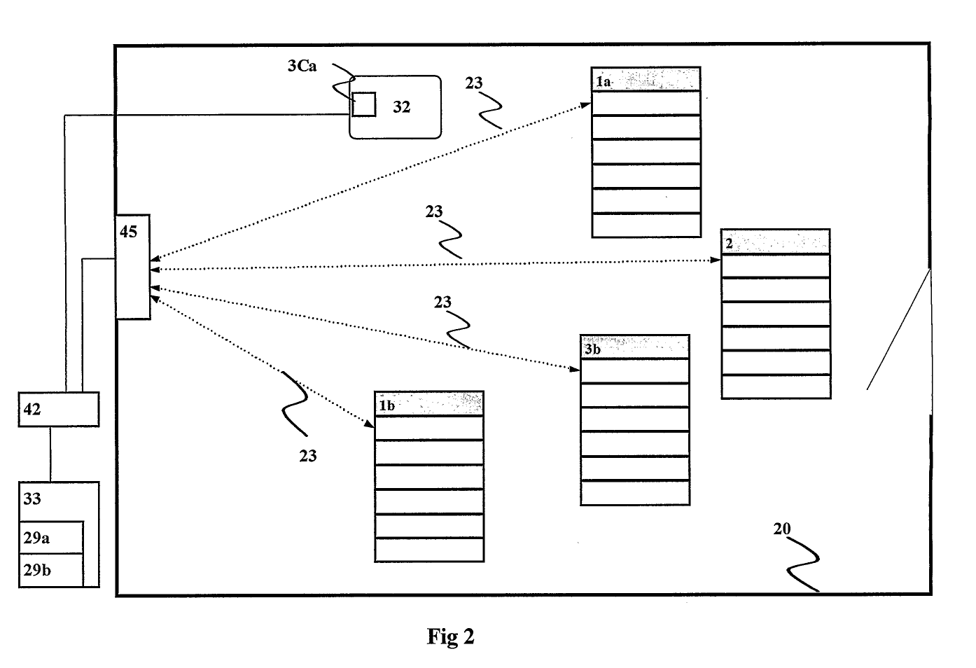

As is evident from FIG. 2, a person tag la is located in a place 20 where at the same time a work object tag 2, a tool tag 3b and a network-connected computer 32, belonging to the individual la, with an integrated software tag 3Ca are located. There is also a person tag 1b carried by another individual who is in the room at the same time.

In the room there is a gateway 45. The tags communicate with the gateway 45, which preferably occurs as encrypted messages 23. When a person tag 1a is within the communication range of the gateway 45, the gateway can establish which other tags 2, 3a and 3b are at the same time positioned in the same room and which other person tag or tags 1b are positioned there at the same time.

Via the network 42, there can now in the server 33 be generated information in the context logs 29a and 29b for the individual with the person tag 1a and for the individual with the person tag 1b with essential information as a function of time. Context information can then be used to generate context graphs which can be sent via the network to other individuals.

In particular the individual with the person tag la can use his information in the context log 29a to show a context graph in the computer 32 and use it in support of work allocation and documentation and let the integrated tag 3Ca communicate information about this directly to the network so that information about this is included in the context log 29a.

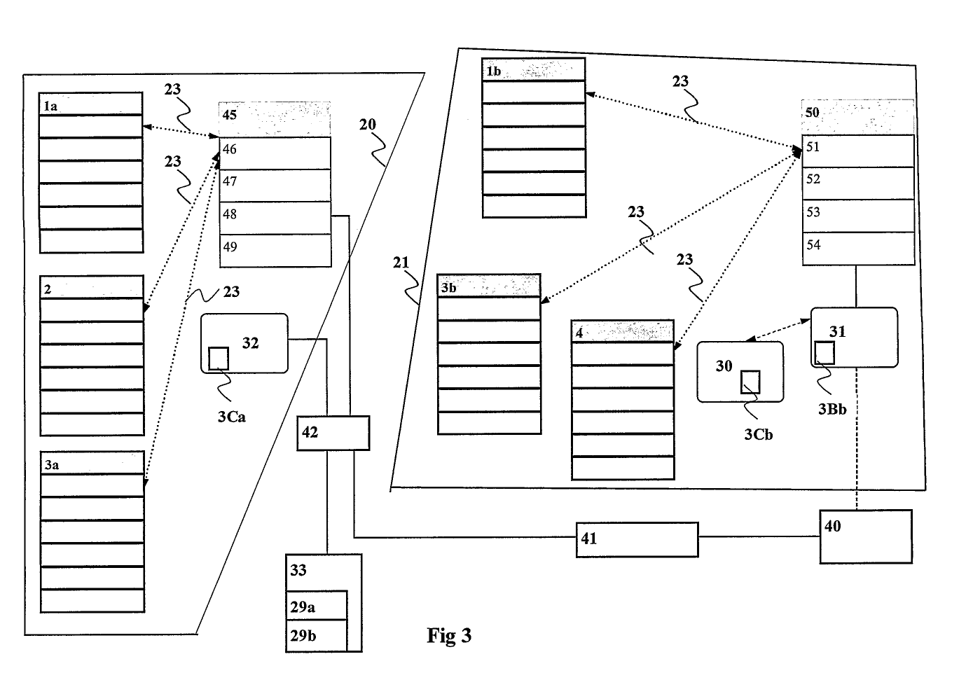

FIG. 3 illustrates how communication related to person tags can be used to generate a context log 29a for the individual who has the person tag 1a and is located place 20 and a log 29b for the individual who has the person tag 1b and is located in the place 21 and transfer them to environments where they can used to generate contextual aspect information, for example in the network-connected computer 32 provided with an integrated software tag 3Ca.

The gateway 45 has one or more antenna systems 46, one ore more radio systems 47 and other electronics 48 for indications, data processing, communication and encryption and cofunction. It also has means for power supply 49, generally permanently, but in some cases a battery or some other power supply not connected to mains may be preferred. The gateway 45 is used to transfer encrypted messages 23 from the person tag 1a when it is positioned within the communication range of the gateway 45. At the same time the gateway 45 can perceive communication from the other tags, the work object tag 2 and the tool tag 3a, which are within its communication range.

Information from the gateway 45 related to the person tag 1a is transferred via the network 42 to the server 33 where a log 29a is generated for the individual, from which it is apparent through which fixed gateway 45 the information has come, which in turn identifies the room where the individual has been positioned. Location information can also come directly from the person tag 1 if it is provided with sensors for determining the position in the room or the geographic position.

In the log 29a for the individual in the server 33, there is also added information about which other tags, work object tag 2 and tool tag 3a, were located in the room at the same time and tags of any other individuals which were also located there. The individual with the person tag 1a can then in the network-connected computer 32 directly via the network 42 interact with his log 29a and the integrated software tag 3Ca can include information about such interaction with the log 29a.

For an individual located in the place 21 and who is not positioned within the communication range of a fixed gateway, it may instead be possible to use a mobile network 40 and have a gateway 50 which is connected to a mobile phone 31. The gateway 50 has one or more antenna systems 51, one or more radio systems 52 and other electronics 53 for indications, data processing, communication and encryption and cofunction. It also has means for power supply 54.

Analogously to that stated above, the person tag 1b, the tool tag 3b and the GPS position tag 4 can communicate with the gateway 50 via the mobile phone 31 and the mobile phone network 40 reach the network connection 41 to the fixed network 42 and its server 33 and there generate a context log 29b for the person tag 1b. In this case, information from the GPS position tag 4 can then be used to define the place 21 where the individual has been located and include this in the context log 29b of the individual. Some mobile phone networks can determine the position of the mobile phone by other methods, and in that case this information can alternatively be collected from the mobile phone operator or from the mobile phone.

The information in the logs 29a and 29b in the server 33 can then be shown on a network-connected computer 32 with the software tag 3Ca or on the mobile phone 31 with the software tag 3Bb. Alternatively, the information can be transferred via the mobile phone 31 to a mobile computer 30 with the software tag 3Cb. Especially if the mobile computer is used at the same time as a tool to compile documentation in the work, this is a convenient and practical solution. When the individual with the person tag 1b interacts with his context log 29b via the mobile computer 30 or the mobile phone 31, information about this can be included in the context log 29 by means of the integrated software tags 3Cb and 3Bb respectively.

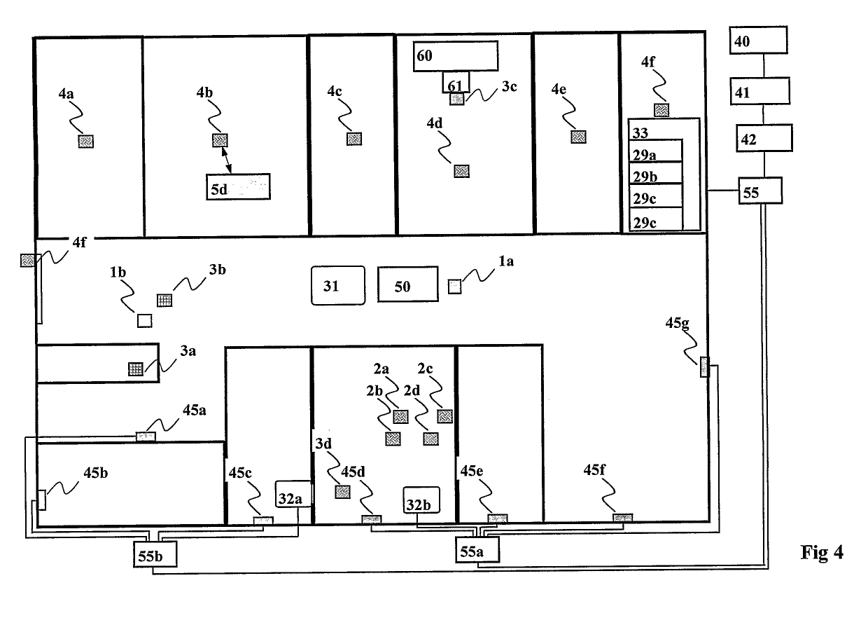

FIG. 4 illustrates what it may look like in a workroom with a plurality of locations (places of presence) where a large number of different tags are positioned, fixed gateways 45a-45g, position tags 4a-4f, tool tags 3a-3d are used and also person tags 1a-1b and a log tag 5d are used.

In the room there is the server 33 which stores information for the logs 29a-29d belonging to the individuals having the respective person tags 1a-1b and log tag 6d. There are also the work object tags 2a-d, which are processed in a machine having the tool tag 3d. The server 33 is connected to the network via the switch 55, which in turn is connected to other switches 55a and 55b conducting the network to the gateways 45a-45g. In the room there are parts with more or less complete coverage of gateways 45a-g. In these areas, it is then possible to continuously generate a complete log in the server 33.

On the occasions the individual is positioned outside the range of the gateways and also has no contact with a mobile network, in the manner illustrated in FIG. 3 and in FIG. 4, information can be stored locally in the log tag 5d. The log 29d can also establish that there is currently no contact with the log tag 5d. The log tag 5d is then assisted by the other tags in the room, for instance the furniture tag 3c which is attached to a chair 61 placed at a desk 60, the position tags 4a-4f. The latter are used to indicate the places of presence that are associated with the respective position tags.

As soon as the log tag 5d is within the range of communication of the gateway 45a-g or, optionally, the mobile gateway 50, information can be transferred from the log tag 6d to its context log 29d in the server 33.

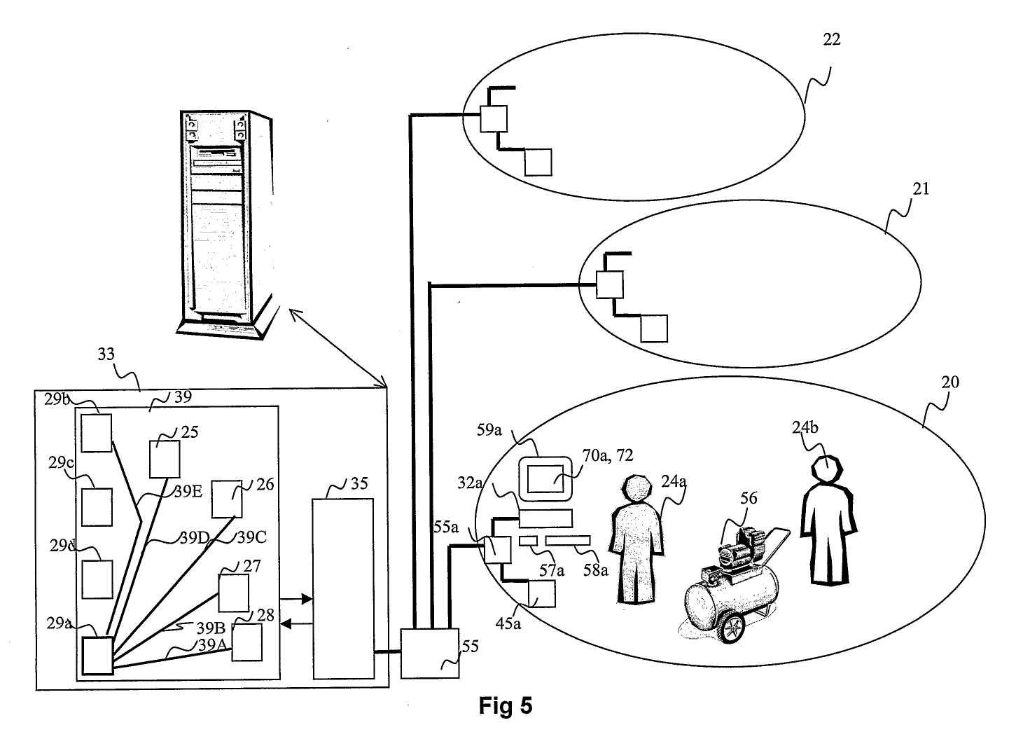

FIG. 5 exemplifies how an individual 24a is located with another individual 24b in a location 20. Information from the context in which the individual 24a is positioned is collected via tags (not shown) from individuals, furniture, tools etc. that are positioned in this location and communicate with the gateway 45a via the switch 55a and 55 to the server 33. These contextual aspects are stored by processor means 35 in the log 29a.

Some alternative locations 21 and 22 for the individual 24a are also indicated in the Figure. Here, too, there is, as indicated, communication with the server 33 via gateways and switches. Information from the context log 29a has been processed by the processor means 35 in the server 33 and presented as a contact graph 70a to the individual 24a on a screen 59a connected to the computer 32a.

A work- or individual-related object 56 is also positioned in the location 20. It is provided with a tool tag (not shown) which can communicate with the gateway 45a and supply its contextual information in the form of a log 27 containing information about contextual aspects related to the object 56. Some of this information is related to the individual 24a via the relation 39B, which means that it will also be included in the log 29a.

Step by step as the individual 24a works, he can guided by the context graph 70a by means of the computer 32 and its pointing device 57a and also its keyboard 58a manually insert supplements to that shown in the context graph 70, such marks being included in the context log 29a and presented in the now accentuated context graph 70a.

The context graph 70a shows graphical traces as a function of time of activities for the object 56. Step by step as various tasks are being performed, the individual 24a can now by means of the pointing device 57a and the keyboard 58a mark the period of time he estimates, guided by the traces in the graph, to have used for a certain task and allocate it to a working account. This information is then saved in the server 33 by processor means 35 in the form of contextual aspect information concerning allocation in the log 26. It is related to the log 29a via the relation 39C, which means that it will also be included in the log 29a. It also means that the context graph can now be still more accentuated.

The documentation performed by the individual 24a while working by means of the computer 32 can be catalogued based on contextual aspects in the context graph 70a. The documentation is indicated by means of an icon in connection with the contextual aspect which is shown in the context graph and to which the individual has chosen to relate it. This may involve, for instance, an observation of what happened to the object 56 just after the work was begun or comments on problems with the task which has been performed and which may need be documented. In this case, it can be natural to catalogue the documentation so that it will be allocated to the working account that is used for the task. The information of the documentation is stored in the server 33 in the documentation log 25. It is related to the log 29a via the relation 39D, which means that it will also be included in the log 29a. It also means that the context graph will now be more accentuated.

On the storage medium 39 information is also stored about the contextual aspects which the individual 24a is not willing to share with other individuals or groups of individuals. Information about this is stored in the log 28 and is related to the log 29a via the relation 39A, which means that this information thus is also included in the log 29a. By means of this information it is controlled, for instance, if the individual 24b is visible in the context graph of the individual 24a when they are located in the same location.

For information collected in the context log 29b of the individual 24b, some information may have been shared with the individual 24a. This has been indicated with the relation 39E and such information from the log 29b will then be included in the log 29a. An example of how to arrange this will be described with reference to the next Figure.

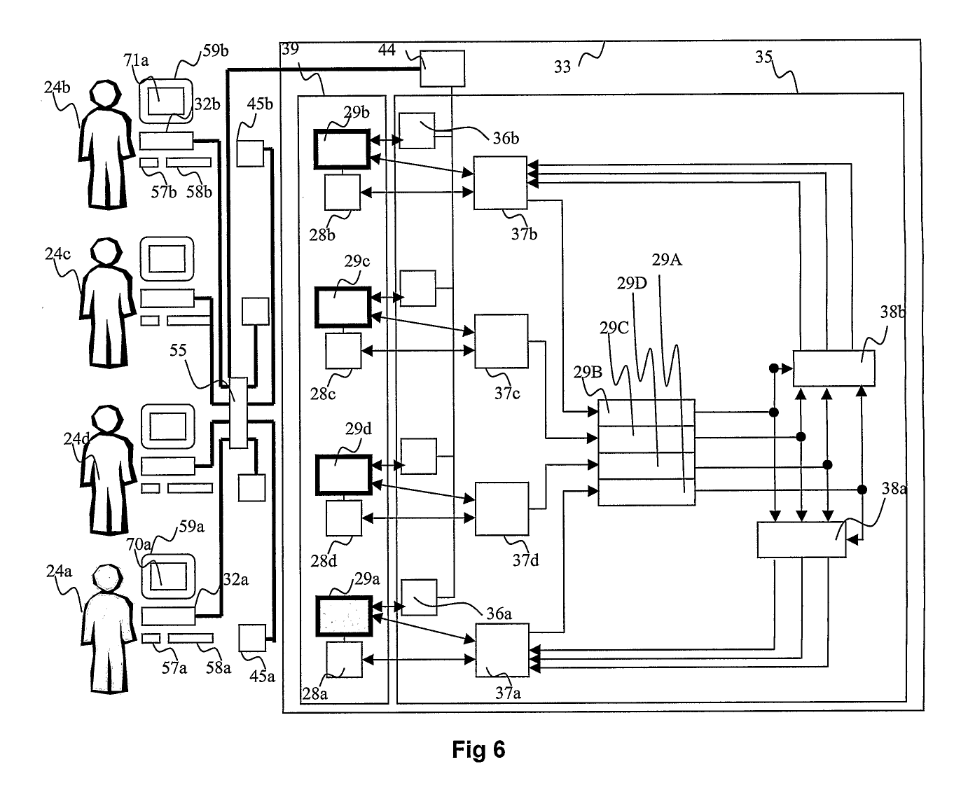

FIG. 6 illustrates how the individuals 24a-d having the logs 29a-d can exchange contextual aspect information. Similar methods can be used to share contextual aspect information between other types of logs.

On his screen, the individual 24a looks at a context graph 70a which concerns himself and to which only he has access. The individual 24b studies on his screen 59b a context graph which is based on the contextual aspects concerning the individual 24a.

The individual 24a controls via his context log 28a which is related to his log 29a which information about aspects of context he is not prepared to share to be included in the work context logs of each member of the group. Such controlling can either be individual towards individual members of the group or equal towards a number of individuals. This information is available in the server 33 stored on the memory medium 39 and controlling occurs by the processor means 35. Step by step as new contextual information comes from tags (not shown) to the gateways 45a, 45b etc, it is forwarded on the network via the switch 55 and the network card 44 to the server 33. This contains sorting means 36a and 36b etc. which ensure that information related to a certain individual or object etc. gets into the correct log. For instance, contextual aspects which are directly related to the individual 24b are guided via the sorting means 36b so that they get into the log 29b.

The individuals 24a-d can define restrictions of the contextual aspect information they are prepared to share. This can be determined, for example, via computer means 32a-b by means of a pointing device 57a-b and a keyboard 58a-b. This information is directed to the storage medium 39 and gets into the logs 28a-d which are related to the respective logs 29a-d and thus is included as related to them or as part of them.

Based on information about restrictions in the logs 28a-d, the database managers 37a-d sort out contextual aspects which each individual is prepared to share with others. Information about these and information about restrictions are then stored in the memories 29A-D. Then the selection means 38a and 38b are used in such a manner that the contents of the memories are compared.

For the individual 24a, contextual aspects in the memory space 29A are compared with contents in the memory spaces 29B-D. Contextual information from the memory spaces 29B-D of the other individuals is then only let through to be included in the context log 29a of the individual 24a provided that the individual 24a has made corresponding information about aspects of context available to the respective individuals for a period of time reciprocal for the respective individuals.

Correspondingly, information from the other individuals' context logs for the individual 24b is compared and processed in the unit 38b. The individuals 24c and 24d have corresponding units which, however, are not shown in the Figure. In this way, the means 39a ensure that the individual 24b cannot be informed about the aspect of context of another member of the group to a greater extent than the extent at which he himself has shared the same type of context for a reciprocal period of time for the respective members of the group.

The reciprocal period of time can be designed in various ways. For instance, it can be a fixed and predetermined period of time which comprises, for example, a day, a week or a month. It may also have a fixed length, but rolling to the present, for instance so that it comprises three hours of the past and six hours of the future. In another method, an individual will be informed about contextual aspects of other individuals a certain time after he has given away the corresponding type of contextual aspects; for instance if he has shared contextual aspect information for a certain day, he will be allowed to receive information of other individuals for a subsequent day.

The method can also be used to arrange that an individual can see another member of the group in his own context log only if he is in the same location and if he also can see the contextual aspect “location” of the individual who sees his contextual aspect “location”. This may occur by defining the reciprocal period of time for this contextual aspect as the same period of time, i.e. when two individuals are in the same place at the same time. It may then be said that there is a short period of time rolling in time. Different reciprocity requirements can be set for different types of contextual aspects.

The method can also be used to control what an individual 24b can see of contextual aspects of an individual 24a on a display 59b which shows a context graph 71a of contextual aspects which the individual 24a is prepared to share. However, contextual aspects are not shown in the context graph 71a to a greater extent than the extent at which the individual 24b has shared the same type of contextual aspects for a reciprocal period of time.

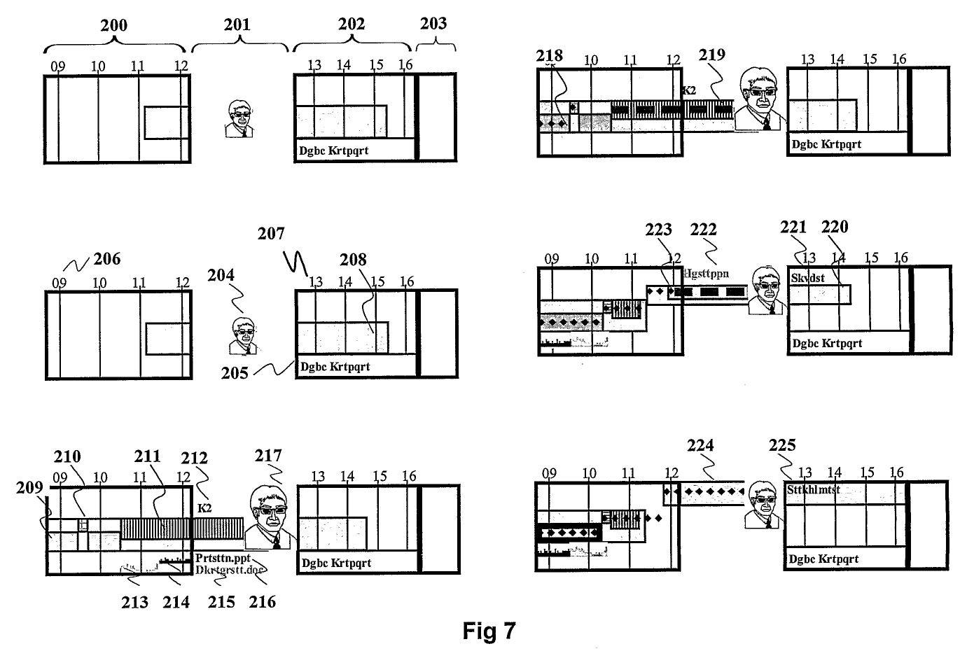

FIG. 7 gives examples of what context graphs may look like and how they can express contextual aspects of an individual. The illustrations reflect how these contextual aspects can be presented to an individual on different occasions.

It is possible to put these miniaturised context graphs of a group of individuals together, one miniature for each individual, to make it possible to see in one glance the appearance of the context at the same time for the entire group. It is also possible to have a plurality of groups where different individuals are included. The exact graphical traces are not limiting, and many variants are conceivable. The traces are illustrated in a grey scale, but it is convenient to use colours to improve perceptibility.

The miniature of an individual consists of three plates. To the left there is the plate for the past 200 (the wake) which shows how the most recent hours have turned out. In the middle there is the real time plate 201 which shows how the situation in near real time turns out for the individual, and there is the future plate 202 which shows the planning for the individual in question for a certain time to come.

The plate designated 203 is used for various symbols, for instance for messages etc. to or from the individual in question. In the real time plate 201, a picture of the individual 204 is suitably placed, and his name is stated in plain text at 105. The past 200 has clock marks 206. In the same manner the future 202 has clock marks 207. How long time the past should cover and how long time the planning should cover depends on the nature of the work in the group.

The purpose of seeing traces of a work situation in the past is to make it easier to assess whether it is possible to reach the individual now or in the time to come. The traces should also indicate whether it may be expected that the individual will be disturbed by a contact attempt.

The planning of the individual 208 indicates when he has planned to arrive at work (just after 11) and when he has planned to leave (between 15 and 16). In this case, the absence of traces indicates that he has not arrived and the reduced picture in the centre of the real time plate is used to symbolise that the system is not in contact with the individual.

In a more trace-rich example of a miniature, it can be seen that the individual is in his room, which is indicated by the trace at the bottom in the presence planning 209. At about 9.30 am, the individual has left his room and walked to another room, which is indicated by a trace 210 higher up. The striped somewhat wider trace 211 indicates that the individual for the time of this trace is in a conference room. On the real time plate there is an extension of the same trace symbol which indicates that the individual at the moment is in the conference room and the name of this is stated 212. The picture of the individual 207 when he is at work is now larger and is shown with full contrast. For instance, the picture is placed to the left if the individual is in his room and to the right if he is somewhere else.

Traces of key and pointing device activities 213 for a document that is stated with text 215 are in this case placed under the presence traces. In this case, it is the document with which the individual has worked most the present day. This can be a signal of great value for those who may want to contact the individual in question. The document with which the individual works right now is indicated at 216 and key and pointing device traces are evident from 214. Focused activities can provide guidance that the individual in question is concentrated on the task at issue and that there is a risk of disturbing his concentration if you contact him.

The individual may be reachable by a mobile phone. In some systems, this can be indicated, or the system may detect and set this. If the individual in question has been open to receive mobile phone calls, this can be indicated by a dotted trace 218. In the same way it can be indicated with a trace if the individual is engaged on the phone 219.

If an individual plans to be in a different place which is also connected to the system by a gateway, this is indicated by a mark 220 and the place is stated in plain text at 221. It is evident from the traces that he arrived somewhat later than planned 223 and at a different place 222 than the place 221 that was planned. Finally, FIG. 4 shows an example of how it is possible to mark that an individual plans to work in a place 225 without connection to the log. This is indicated by a wider planning trace 224 at the top.

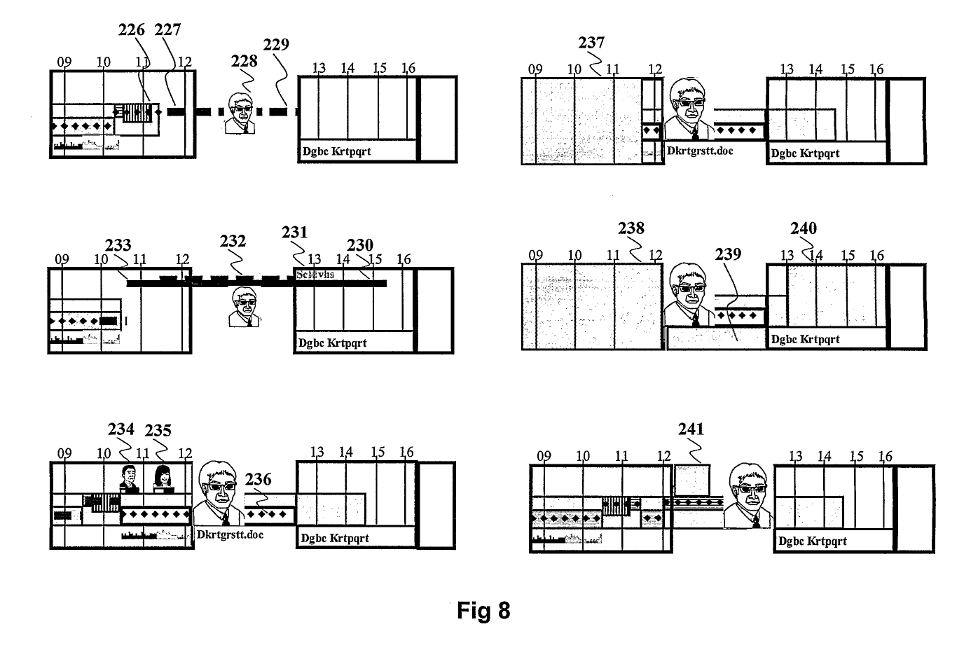

FIG. 8 shows by way of introduction further examples of context graphs. One example shows that the individual left work just after 11 am and then left a conference room 226. At about 11.30 am he began a phone call which is still going on 229. The picture 229 of the individual is placed in the centre of the real time plate, which indicates that the system is not in contact with him but that it detects his phone status.

The next example illustrates when the individual has planned absence, in this case sickness absence, which is indicated by the bar 230. The character of the absence is stated in plain text 231. The individual left work at 10.30 am, which is evident from the trace 233. At 11.30 am he began to speak on the telephone and he still does at the current moment, which is evident from the trace 232.

The following examples illustrate that it is possible to use pictures to illustrate which individuals 234 and 235 are to be found as visitors in a workroom. In the lower part of the pictures there are indicators indicating for how long the individuals have been in the room. When a visitor's chair indicates a visitor in the workroom, the presence signal can indicate that the individual is engaged 236. The same or a similar signal can be set manually or there may be a tag detecting that the individual has closed the door.

The principles of the system imply that an individual can only see other individuals' aspects of work context which he is prepared to show and for a corresponding or reciprocal period of time. The grey field 237 indicates that an individual does not want to show more than about 30 min of his past. Then he cannot see other individuals' past further, which this illustrates.

In the next example, the entire plate of the past has been masked. Also the computer applications with which an individual works are concealed 239, as are also parts of planned time 240.

Finally, an example 241 shows that the name of the place where an individual is at the moment is masked away.

Thus, each individual controls which contextual aspects he wants to share with others, but can only study other individuals' contextual aspects to a corresponding degree.

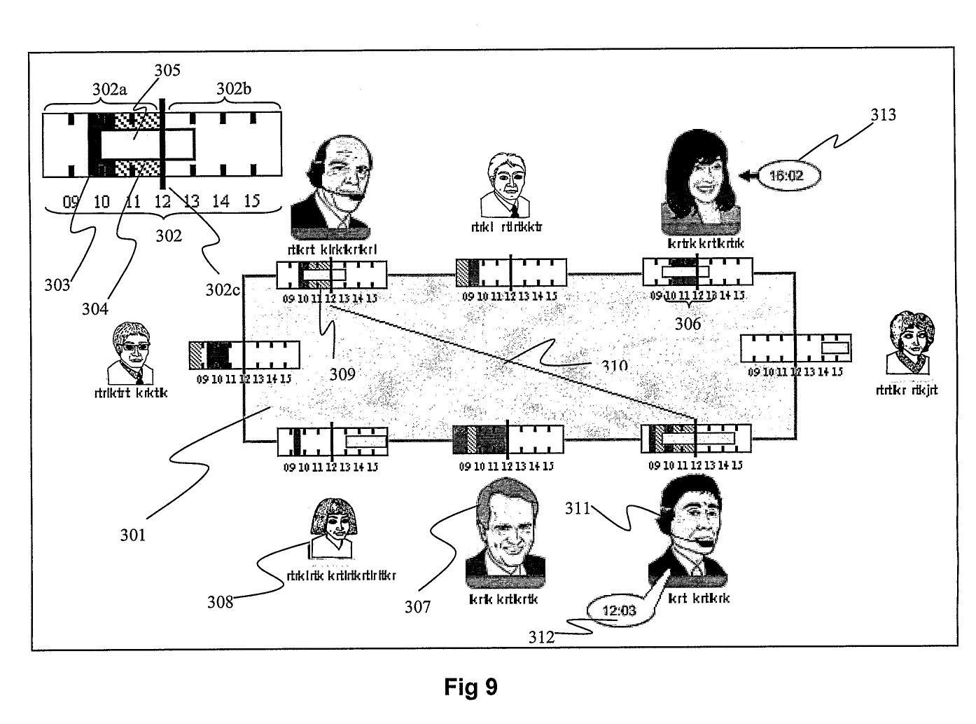

FIG. 9 shows an example of how aspects of context can be illustrated for a group of individuals which cooperate, maybe in a more social manner. People may be involved, who live in different places but who cooperate socially to help each other to handle a problem that concerns all of them.

For these individuals, it may be important to be able to establish an interactive contact with each other in a simple manner. This can be achieved as follows. There is a communication place in the home of each individual where the individual can seat himself and thus automatically indicate that he is available to be contacted by someone else in the group. This place can be identical to the place where the individual normally reads his newspaper or has coffee, and when he is in this place he is engaged with matters that are not so important that he minds being interrupted. In this place there is a computer monitor that presents a contextual aspect graph corresponding to this figure.

In the contextual aspect graph there is a symbolic conference table 301 which in the example accommodates eight people. Each individual is represented by a photo with his name under it. On the symbolic table in front of each individual, there is a contextual aspect plate 302 which is divided into two parts, one showing a period comprising, for instance, four hours of the past 302a and the other four hours of the future 302b. In the joint between these two parts, the present is indicated 302c. The contextual aspect plate shows as a function of the past the individual's presence 303 at the communication table and also communication with another member of the group 304.

On the indicator there is also room to show planned contextual aspects in the form of, for instance, presence 305 at the communication table. A planned presence is also shown with contextual aspect traces in the past at the moment when planned presence changes into the present and is shown on the contextual aspect indicator 306. This makes it possible to obtain an image of how consistent an individual is when he marks his future presence.

An individual's present contextual aspect is shown by the individual's photo. If the individual's contextual aspect log registers that he is in a communication place, this is shown by the photo being enlarged and in colour 307. If the individual's contextual aspect log does not register that he is in a communication place, a smaller picture in black-and-white with low contrast 308 is shown instead.

To contact one of the individuals, it is sufficient to interact by a pointing device with the picture of the individual with whom you want to communicate. When this happens, for instance a voice contact can be established by telephone and this is indicated as long as the conversation is going on the respective individuals' contextual aspect plate 309. The individuals talking to each other are shown, for example, by lines connecting the respective individuals' contextual aspect plates to their present time lines 310. The contextual aspect in calls in present time can be indicated on the individual's picture in the form of a superposed symbolic communication object 311.

If an individual you want to reach should not be there, it is possible to leave a voice message or a written message. This happens by interacting with the individual's picture using a pointing device and then reading a message or writing a message. The contextual aspect that a message has been delivered to an individual can be shown, for example, by an icon with a time indication 312. If it is desirable to read the message once more, this can be done by interacting with the icon using a pointing device.

If you have received a message from an individual, this can be indicated by an icon with a time statement 313 at the individual who delivered the message, and it is possible to read the message by interacting with the icon by a pointing device.

1. A method for a second individual having a context log which contains information about contextual aspects, related to the second individual, as a function of time, to read information from a first individual's context log which contains information about contextual aspects, related to the first individual, as a function of time, characterised by generating, from information from the context log of the first individual, a context graph, available to the second individual, of the first individual which shows contextual aspects as a function of time, and including in the context graph at least a contextual aspect which refers to at least one location of the first individual and a contextual aspect which refers to at least one activity on a work- or individual-related object with the same location as the first individual, and showing by the context graph contextual aspects for a period of time which comprises both present time and a period of the past in connection with the present time.

2. A method as claimed in claim 1, characterised in that at least one further shown contextual aspect refers to at least one of alternative places of sojourn of the first individual, a contextual aspect of another individual with the same location as for the first individual, a planned contextual aspect as a function of future time of the first individual, how a planned contextual aspect was planned for the first individual when it changed from future to present, allocated time for a task of an individual, a contextual aspect referring to allocated time for used time for a work- or individual-related object, a contextual aspect referring to a work- or individual-related object with the same location as for the first individual, or a contextual aspect for documentation related to the first individual or to his work.

3. A method as claimed in claim 2, characterised in that for a work- or individual-related object at least one shown contextual aspect refers to keyboard activity, pointing device activity, active application, file name connected to active application, printout on printer, number of sheets printed on printer, working posture, setting of tool, engaged, switched off or somehow reachable, called individual, dialled phone number, called by an individual or called by a telephone number.

4. A method as claimed in claim 2, characterised in that, for documentation related to the first individual or to his work, at least one shown contextual aspect refers to cataloguing based on allocation, cataloguing based on another contextual aspect or other contextual aspects or communication of documentation related to one or more individuals at least in one of the respects sent to, received from, opened by, checked by, read by, commented on by or printed by.

5. A method as claimed in one or more of the preceding claims, characterised in that at least information about restriction of availability of a contextual aspect made by the second individual in relation to the first individual, in relation to one or more additional individuals or in relation to one or more groups of individuals, is included in the contextual aspect log of the second individual and that at least one of the consequences of these restrictions can be shown in the context graph of the first individual which is available to the second individual.

6. A method as claimed in one or more of the preceding claims, characterised in that the context graph of the first individual, which is available to the second individual, does not show contextual aspects as a function of time of the first individual to a greater extent than the extent at which the second individual has made his own information about corresponding contextual aspects available to the first individual for a reciprocal period of time.

7. A method as claimed in claim 6, characterised in that the reciprocal period of time is formed of at least one of the alternatives that it extends over a period of time which is fixed and predetermined in time, that it has a fixed length but rolling in time, that it extends over a period of time which has a predetermined relationship with the present time, that it contains at least a part which is future time, or that it corresponds to a period of time for which the second individual has made information about contextual aspects available to the first individual and a certain additional period of time after the last such period of time.

8. A method as claimed in one or more of the preceding claims, characterised by showing, available to the second individual, in connection with the context graph of the first individual, also at least one corresponding context graph of the second individual or of one or more additional individuals.

9. An arrangement for a second individual having a context log (29b), stored on a memory medium (39), which contains information about contextual aspects, related to the second individual, as a function of time, to read information from a first individual's context log (29a) containing information about contextual aspects, related to the first individual, as a function of time, characterised in that means (35) are arranged to select contextual aspect information from the context log (29a) of the first individual and, available to the second individual, generate and present, by image display means (59b), a context graph (71a) of the first individual that shows contextual aspects as a function of time, and in the context graph (71a), include at least a contextual aspect which refers to at least one location of the first individual and a contextual aspect which refers to at least one activity on a work- or individual-related object with the same location as the first individual, and that the context graph (71a) shows contextual aspects for a period of time which comprises both present time and a period of the past in connection with the present time.

10. An arrangement as claimed in claim 9, characterised in that means (35) are arranged to at least show one additional contextual aspect which refers to at least one of alternative places of sojourn of the first individual, a contextual aspect of another individual with the same location as for the first individual, a planned contextual aspect as a function of future time of the first individual, how a planned contextual aspect was planned for the first individual when it changed from future to present, a contextual aspect which refers to allocated time for a task of an individual, a contextual aspect for allocated time for used time for a work- or individual-related object, a contextual aspect which refers to a work- or individual-related object with the same location as for the first individual, or a contextual aspect for documentation related to the first individual or to his work.

11. An arrangement as claimed in claim 10, characterised in that means (35) are arranged for a work- or individual-related object so that at least one contextual aspect refers to keyboard activity, pointing device activity, active application, file name connected to active application, printout on printer, number of sheets printed on printer, working posture, setting of tool, engaged, switched off or somehow reachable, called individual, dialled phone number, called by an individual or called by a telephone number.

12. An arrangement as claimed in claim 10, characterised in that means (35) are arranged for documentation related to the first individual or to his work so that at least one shown contextual aspect refers to cataloguing based on allocation, cataloguing based on another contextual aspect or other contextual aspects or communication of documentation related to one or more individuals at least in one of the respects sent to, received from, opened by, checked by, read by, commented on by or printed by.

13. An arrangement as claimed in one or more claims 9-12, characterised in that means (35) are arranged to include in the context log (29b) of the second individual at least information (27b) about restriction of availability of a contextual aspect made by the second individual in relation to the first individual, in relation to one or more additional individuals or in relation to one or more groups of individuals, and that means are arranged so that at least one of the consequences of these restrictions can be shown in the context graph (71a) of the first individual which is available to the second individual.

14. An arrangement as claimed in one or more of claims 9-13, characterised in that means (35) are arranged to control that in the context graph (71a) of the first individual, which is available to the second individual, contextual aspects are not shown as a function of time of the first individual to a greater extent than the extent at which the second individual has made his own information about corresponding contextual aspects available to the first individual for a reciprocal period of time.

15. An arrangement as claimed in one or more of claims 9-14, characterised in that means (35) are arranged to form the reciprocal period of time with at least one of the alternatives that it extends over a period of time which is fixed and predetermined in time, that it has a fixed length but rolling in time, that it extends over a period of time which has a predetermined relationship with the present time, that it contains at least a part which is future time, or that it corresponds to a period of time for which the second individual has made information about contextual aspects available to the first individual and a certain additional period of time after the last such period of time.

16. An arrangement as claimed in one or more of claims 9-15, characterised in that means (35) are arranged to show, available to the second individual, in connection with the context graph (71a) of the first individual, also at least one corresponding context graph of the second individual or one or more other individuals.
